(19) United States
(12) Patent Application Publication
(10) Pub. No.: US 2025/0091653 A1
(43) Pub. Date: Mar. 20, 2025

(54) JOINT STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Yongbai Joo, Hwaseong-si (KR); Joonghyun Shin, Hwaseong-si (KR); Jaeseung Lee, Hwaseong-si (KR); Jungsuk Lee, Hwaseong-si (KR); Byung Jin Son, Hwaseong-si (KR); Dae Hee Lee, Hwaseong-si (KR); Jin Ho Hwang, Hwaseong-si (KR); Chulhee Heo, Hwaseong-si (KR); Hyungsik Choi, Hwaseong-si (KR)

(21) Appl. No.: 18/818,845

(22) Filed: Aug. 29, 2024

(30) Foreign Application Priority Data
Sep. 20, 2023 (KR) 10-2023-0125388

(51) Int. Cl. B62D 25/08; B62D 25/06; B62D 27/06

(52) U.S. Cl. CPC B62D 25/08; B62D 25/06; B62D 27/06

(57) ABSTRACT

An embodiment joint structure of a vehicle body is provided. The vehicle body includes a front body module fixed to an under body and a rear body module that is detachably coupled to the front body module along a front to rear direction of the vehicle body, and the joint structure includes a joint unit disposed in a rear portion of the front body module and a front portion of the rear body module, respectively, a striker mounted on an outside of a first closed cross-section defined in either the rear portion of the front body module or the front portion of the rear body module, and a latch assembly disposed on an inside of a second closed cross-section defined in the other of the rear portion of the front body module and the front portion of the rear body module.

### CROSS-REFERENCE TO RELATED APPLICATIONS

This application claims the benefit of Korean Patent Application No. 10-2023-0125388, filed on Sep. 20, 2023, which application is hereby incorporated herein by reference.

### TECHNICAL FIELD

The present invention relates to a vehicle body.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. The PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of the PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

As described above, the cost of changing the structure of the upper body may increase according to the various customized services of the PBV.

Matters described in this background section are prepared to enhance understanding of the background of embodiments of the invention and may include matters other than already known prior art.

### SUMMARY

The present invention relates to a vehicle body. Particular embodiments relate to a joint structure of a vehicle body, for example, a PBV.

Embodiments of the present disclosure provide a joint structure of a vehicle body that can be replaced with various types of vehicle bodies according to the type of customized service of the PBV.

A joint structure according to an exemplary embodiment may be applied to a vehicle body including a front body module fixed to an under body and a rear body module that is detachably coupled to the front body module along the front to rear direction of the vehicle body. The joint structure according to an exemplary embodiment may include a joint unit installed in a rear portion of the front body module and a front portion of the rear body module, respectively, a striker mounted on an outside of a closed cross-section formed in one of the rear portion of the front body module and the front portion of the rear body module, and a latch assembly installed on an inside of a closed cross-section formed on the other of the rear portion of the front body module and the front portion of the rear body module.

The front body module may include a fixed part roof rail assembly with a fixed part closed cross-section connected with a fixed part roof panel.

The rear body module may include a variable part roof rail assembly with a variable part closed cross-section connected with a variable part roof panel.

The striker may be mounted on the outside of the variable part closed cross-section.

The latch assembly may be installed on the inside of the fixed part closed cross-section.

The striker may be locked and unlocked with the latch assembly through a striker passing hole formed in the fixed part roof rail assembly.

The front body module may include a latch mounting unit connected to the inside of the fixed part closed cross-section and connected to the latch assembly.

The rear body module may include a striker mounting unit connected to the inside of the variable part closed cross-section and connected to the striker.

The fixed part roof rail assembly may include a fixed part roof rail connected with a fixed part roof panel and a fixed part roof cover connected with the fixed part roof panel and the fixed part roof rail.

The latch mounting unit may include a latch mounting bulk head, connected with the fixed part roof rail and the fixed part roof cover and connected with the latch assembly, and a pair of support bulk heads each connected to both sides of the latch mounting bulk head with the latch mounting bulk head in between and connected with the fixed part roof cover.

The variable part roof rail assembly may include a variable part roof rail connected with the variable part roof panel, a variable part rail extension member connected with the variable part roof rail, and a variable part roof cover combined with the variable part roof panel and the variable part rail extension member.

The striker mounting unit may include a striker mounting bulk head that is connected with the variable part roof rail, the variable part rail extension member, and the variable part roof cover and is connected with the striker with the variable part roof cover in between.

A joint structure according to an exemplary embodiment may be applied to a vehicle body including a front body module fixed to an under body and a rear body module that is detachably coupled to the front body module along the front to rear direction of the vehicle body.

The joint structure according to an exemplary embodiment may include a joint unit installed in a rear portion of the front body module and a front portion of the rear body module, respectively, a fixed part sealing flange formed on a fixed part roof rail assembly, a fixed part center pillar assembly, and a fixed part floor assembly respectively connected to a rear portion of the front body module to mount a fixed part inner sealing member, and a variable part sealing flange formed on a variable part roof rail assembly, a variable part center pillar assembly, and a variable part floor assembly respectively connected to a front portion of the rear body module to mount a variable part inner sealing member.

The fixed part roof rail assembly may include a fixed part roof rail connected to a fixed part roof panel and a fixed part roof cover connected to the fixed part roof panel and the fixed part roof rail.

The variable part roof rail assembly may include a variable part roof rail connected with a variable part roof panel, a variable part rail extension member connected with the variable part roof rail, and a variable part roof cover connected with the variable part roof panel and the variable part rail extension member.

The fixed part sealing flange may be formed on the fixed part roof cover.

The variable part sealing flange may be formed on the variable part roof rail and the variable part roof cover.

The fixed part center pillar assembly may include a fixed part center pillar and a fixed part pillar cover connected to the fixed part center pillar.

The variable part center pillar assembly may include a variable part center pillar and a variable part pillar cover connected to the variable part center pillar.

The fixed part sealing flange may be formed on the fixed part pillar cover.

The variable part sealing flange may be formed on the variable part center pillar and the variable part pillar cover.

The fixed part floor assembly may include a fixed part upper cross member connected to the fixed part floor panel.

The variable part floor assembly may include a variable part upper cross member connected to a variable part floor panel, a variable part floor extension member connected to the variable part upper cross member, and a variable part floor cover connected to the variable part floor panel and the variable part upper cross member.

The fixed part sealing flange may be formed on the fixed part upper cross member.

The variable part sealing flange may be formed on the variable part floor extension member and the variable part floor cover.

The fixed part sealing flange and the variable part sealing flange may be provided as stoppers to prevent rotation of the rear body module.

According to exemplary embodiments of the disclosure, cost savings can be achieved by configuring the vehicle body to suit the various customized services of the PBV.

According to exemplary embodiments of the disclosure, the combined strength, skeletal strength, and watertight performance of the front body module and the rear body module, which are detachable from each other, can be secured.

In addition, effects that can be obtained or expected due to embodiments of the present invention will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are for reference in explaining exemplary embodiments of the present invention, the technical idea of the present invention should not be construed as being limited to the accompanying drawings.

FIG. 1 is an exploded perspective view showing a joint structure of a vehicle body according to an exemplary embodiment.

FIG. 2 is an exploded perspective view showing a front body module and a rear body module applied to the joint structure of a vehicle body according to an exemplary embodiment.

FIG. 3 is a perspective view showing the front body module applied to the joint structure of a vehicle body according to an exemplary embodiment.

FIG. 4 is an exploded perspective view showing the front body module applied to the joint structure of a vehicle body according to an exemplary embodiment.

FIG. 5 is a cross-sectional view showing a roof rail assembly of a fixed part of the front body module applied to the joint structure of a vehicle body according to an exemplary embodiment.

FIG. 6 is a cross-sectional view showing a fixed part center pillar assembly of the front body module applied to the joint structure of a vehicle body according to an exemplary embodiment.

FIG. 7 is a cross-sectional view showing a fixed part floor assembly of the front body module applied to the joint structure of a vehicle body according to an exemplary embodiment.

FIG. 8 is a perspective view showing the rear body module applied to the joint structure of a vehicle body according to an exemplary embodiment.

FIG. 9 is an exploded perspective view showing the rear body module applied to the joint structure of a vehicle body according to an exemplary embodiment.

FIG. 10 is a cross-sectional view showing a roof rail assembly of a variable part of the rear body module applied to the joint structure of a vehicle body according to an exemplary embodiment.

FIG. 11 is a cross-sectional view showing a variable part center pillar assembly of the rear body module applied to the joint structure of a vehicle body according to an exemplary embodiment.

FIG. 12 is a cross-sectional view showing a variable part floor assembly of the rear body module applied to the joint structure of a vehicle body according to an exemplary embodiment.

FIG. 13A and FIG. 13B are cross-sectional views showing a mounting structure of a fixed part joint of a joint unit applied to the joint structure of a vehicle body according to an exemplary embodiment.

FIG. 14A and FIG. 14B are cross-sectional views showing a mounting structure of a variable part joint of the joint unit applied to the joint structure of a vehicle body according to an exemplary embodiment.

FIG. 15A and FIG. 15B are cross-sectional views showing a mounting structure of a latch assembly applied to the joint structure of a vehicle body according to an exemplary embodiment.

FIG. 16 is a cross-sectional view showing a mounting structure of a striker applied to the joint structure of a vehicle body according to an exemplary embodiment.

FIG. 17 to FIG. 22 are drawings to explain operations of the joint structure of a vehicle body according to an exemplary embodiment.

The following reference identifiers may be used in connection with the drawings to describe various features of embodiments of the present invention.

| | |
|---|---|
| 1: under body | 3: upper body |
| 100: joint structure | 110: front body module |
| 110a: fixed part | 111: fixed part cover panel |
| 113: fixed part roof cover | 113a: striker passing hole |
| 114, 116, 176: fixed part sealing | 115: fixed part pillar cover |
| flange | |
| 121: fixed part roof panel | 131: fixed part roof rail assembly |
| 133: fixed part roof rail | 141, 161: fixed part closed cross- |
| | section |
| 151: fixed part center pillar assembly | 153: fixed part center pillar |
| 171: fixed part floor assembly | 173: fixed part floor panel |
| 175: fixed part upper cross member | 210: rear body module |
| 210a: variable part | 211: variable part cover panel |
| 213: variable part roof cover | 213a, 215a: joint passing hole |
| 214, 216, 218, 234, 254, 278: | |
| variable part sealing flange | |
| 215: variable part pillar cover | 217: variable part floor cover |
| 221: variable part roof panel | 231: variable part roof rail |
| | assembly |
| 233: variable part roof rail | 235: variable part rail extension |
| | member |
| 241, 261: variable part closed cross- | |
| section | |
| 251: variable part center pillar | |
| assembly | |
| 253: variable part center pillar | 271: variable part floor assembly |
| 273: variable part floor panel | 275: variable part upper cross |
| | member |
| 277: variable part floor extension | |
| member | |
| 310: joint unit | 331: fixed part joint |
| 351: variable part joint | 410: striker |
| 431: striker mounting unit | 433: striker mounting bulk head |
| 510: latch assembly | 511: latch part |
| 513: latch lock part | 531: latch mounting unit |
| 533: latch mounting bulk head | 535: support bulk head |
| 610: fixed part inner sealing member | 710: variable part inner sealing |
| | member |
| 810: molding member | 910: outer sealing member |
| 990: stopper | |

The drawings referenced above are not necessarily drawn to scale, but they should be understood as presenting a somewhat simplified representation of various preferred features illustrating the basic principles of embodiments of the present invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the present invention. As those skilled in the art would realize, the described embodiments may be modified in various different ways, all without departing from the spirit or scope of the present invention.

The terminology used herein is for the purpose of describing specific embodiments only and is not intended to limit the disclosure. As used herein, singular forms are intended to also include plural forms, unless the context clearly indicates otherwise.

As used herein, the terms ‘comprise’ and/or ‘comprising’ indicate the presence of specified features, integers, steps, operations, elements, and/or components, but they may also include, and do not exclude the presence or addition of, one or more other features, integers, steps, operations, elements, components, and/or groups thereof.

As used herein, the term ‘and/or’ includes any one or all combinations of one or more items listed in association.

In this specification, the term ‘connected’ indicates a physical relationship between two components in which the components are directly connected to each other by welding, rivets, self piercing rivet (SPR), flow drill screw (FDS), structural adhesive, etc. or indirectly connected through one or more intermediate components.

As used herein, ‘vehicle,’ ‘vehicular,’‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

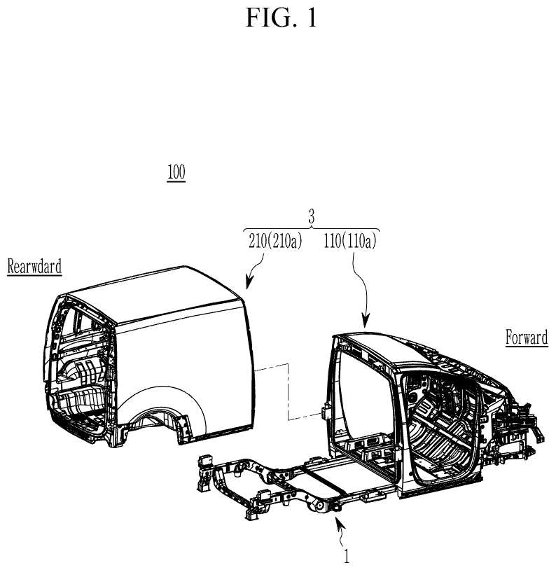

FIG. 1 is an exploded perspective view showing a joint structure of a vehicle body according to an exemplary embodiment.

Referring to FIG. 1, a joint structure 100 of a vehicle body according to an exemplary embodiment may be applied to, for example, a vehicle body of a purpose-based mobility vehicle (Purpose Built Vehicle: hereinafter referred to as a ‘PBV’).

The PBV may be used as an electric vehicle-based life module vehicle that provides various services to occupants while moving from one place to a destination in an unmanned self-driving manner.

In one example, the PBV may be manufactured in a one box type design with a large interior space. The PBV may also apply facing type seats to the interior space.

The vehicle body of such a PBV is suitable for small quantity production of various vehicle types with a small number of parts and may be manufactured in various shapes and sizes.

The vehicle body of the PBV includes a skateboard type under body 1 (commonly referred to as a ‘rolling chassis’ or ‘chassis frame’ by those skilled in the art) and an upper body 3 assembled to the under body 1.

Components such as a battery assembly and a drive motor may be mounted on the under body 1. The upper body 3 is a body in white (BIW) body connected to the under body 1 and can constitute a cabin and luggage room with a wide indoor space.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The joint structure 100 according to an exemplary embodiment may be a structure that can apply various types of the upper body 3 to the under body 1 according to the type of customized service of the PBV.

For this purpose, the joint structure 100 according to an exemplary embodiment includes a front body module 110 and a rear body module 210 as the upper body 3.

The front body module 110 includes a cab type front cabin. The front body module 110 may be fixed to the front part of the under body 1.

The front body module 110 may be coupled to the front part of the under body 1 along a vertical direction through a vehicle body mounting unit known to a person of ordinary skill in the art. This front body module 110 may be provided as a fixed part 110a fixed to the front part of the under body 1.

The rear body module 210 may include a rear cabin or luggage room. The rear body module 210 is removably provided at the upper part of the under body 1 and the rear part of the front body module 110.

The rear body module 210 may be attached and detached from the rear part of the under body 1 along the vertical direction. In addition, the rear body module 210 may be attached and detached to the rear of the front body module 110 in the front to rear direction of the vehicle body. This rear body module 210 may be manufactured in various shapes depending on the purpose of the PBV.

The rear body module 210 may be provided as a detachable variable part 210a at the upper part of the under body 1 and the rear part of the front body module 110.

That is, the rear body module 210 may form a rear cabin at the rear of the vehicle body. Additionally, the rear body module 210 may form a hailing type upper body 3 together with the front body module 110.

Furthermore, the rear body module 210 may form a luggage room at the rear of the vehicle body. Additionally, the rear body module 210 may form a delivery type upper body 3 together with the front body module 110.

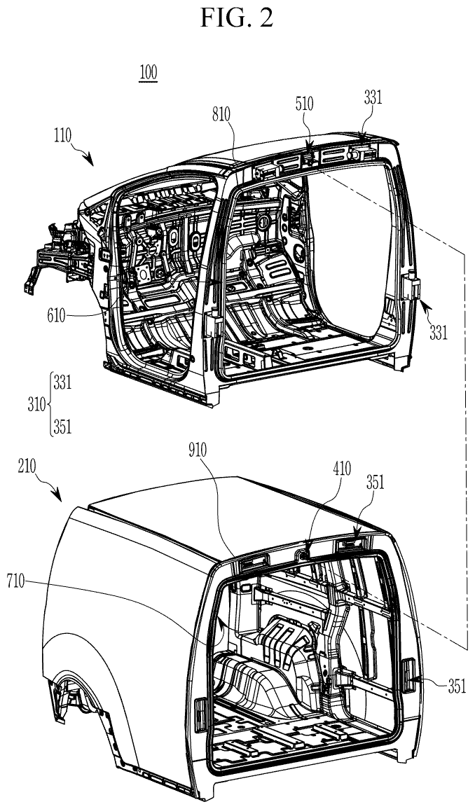

FIG. 2 is an exploded perspective view showing a front body module and a rear body module applied to the joint structure of a vehicle body according to an exemplary embodiment.

Referring to FIG. 1 and FIG. 2, according to an exemplary embodiment, the joint structure 100 may further include a joint unit 310, a striker 410, a latch assembly 510, a fixed part inner sealing member 610, and a variable part inner sealing member 710.

In an embodiment, the joint unit 310 is configured to attach and detach the front body module 110 and the rear body module 210 in the front to rear direction of the vehicle body.

The joint unit 310 is mounted on the rear portion of the front body module 110 and the front portion of the rear body module 210, respectively.

In one example, this joint unit 310 may include a plurality of fixed part joints 331 and a plurality of variable part joints 351.

The fixed part joints 331 may be installed in the rear portion of the front body module 110. And, the variable part joints 351 may be installed in the front portion of the rear body module 210.

The fixed part joints 331 and the variable part joints 351 may be joined with each other or separated from each other. In one example, the fixed part joints 331 and the variable part joints 351 may be mechanically locked or unlocked by manual or automatic methods.

In another example, the fixed part joints 331 and the variable part joints 351 may be locked or unlocked mechanically and may also be locked or unlocked by magnetic force and electromagnetic force.

In another such example, the fixed part joints 331 may include a magnetic module including a combination of a circular magnet, a linear magnet, a coil, and a locking member that rotates by operation of a motor. In addition, the variable part joints 351 are locked or unlocked with the fixed part joints 331 by magnetic force and electromagnetic force generated from the fixed part joints 331, and the armature block (e.g., steel block) is mechanically locked or unlocked with the locking member.

In addition, the fixed part joints 331 and the variable part joints 351 may be structured to be mutually lockable or unlockable in various ways that are obvious to those skilled in the art.

In embodiments of the disclosure, the striker 410 and the latch assembly 510 are configured to latch together.

In addition, the striker 410 and the latch assembly 510 are configured to prevent separation of the front body module 110 and the rear body module 210 when the coupling force between the fixed part joints 331 and the variable part joints 351 is insufficient or lost.

The striker 410 is mounted on one of the rear portion of the front body module 110 and the front portion of the rear body module 210. And, the latch assembly 510 is mounted on the other one of the rear portion of the front body module 110 and the front portion of the rear body module 210.

In one example, the striker 410 may be mounted on the front portion of the rear body module 210. And, the latch assembly 510 may be mounted on the rear portion of the front body module 110.

In embodiments of the disclosure, the fixed part inner sealing member 610 and the variable part inner sealing member 710 are configured to seal the inside of the front body module 110 and the rear body module 210, which are joined to each other by the joint unit 310, the striker 410, and the latch assembly 510.

The fixed part inner sealing member 610 is mounted on the rear portion of the front body module 110. And, the variable part inner sealing member 710 is mounted on the front portion of the rear body module 210.

In one example, the fixed part inner sealing member 610 and the variable part inner sealing member 710 may include weatherstrips of rubber material.

Meanwhile, according to an exemplary embodiment, the joint structure 100 may further include a molding member 810 and an outer sealing member 910.

The molding member 810 and the outer sealing member 910 are configured to seal the outside of the front body module 110 and the rear body module 210 that are coupled to each other.

The molding member 810 may be mounted on the rear portion of the front body module 110. The outer sealing member 910 may be mounted on the front portion of the rear body module 210.

This molding member 810 may be formed of a plastic material. Additionally, the outer sealing member 910 may include a weather-strip of a rubber material.

Hereinafter, the mounting structures of the joint unit 310, the striker 410, the latch assembly 510, the fixed part inner sealing member 610, and the variable part inner sealing member 710 will be described in detail with reference to the accompanying drawings.

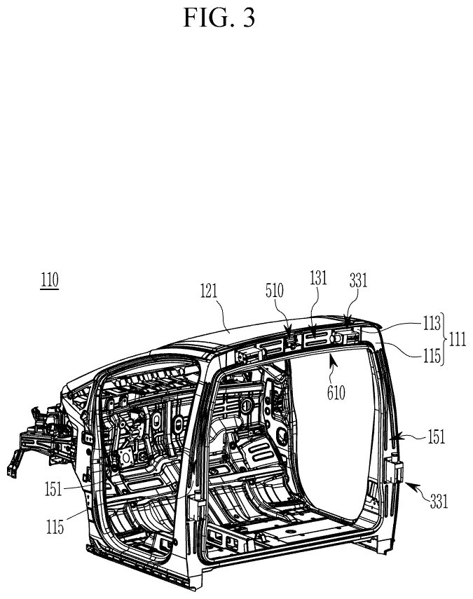

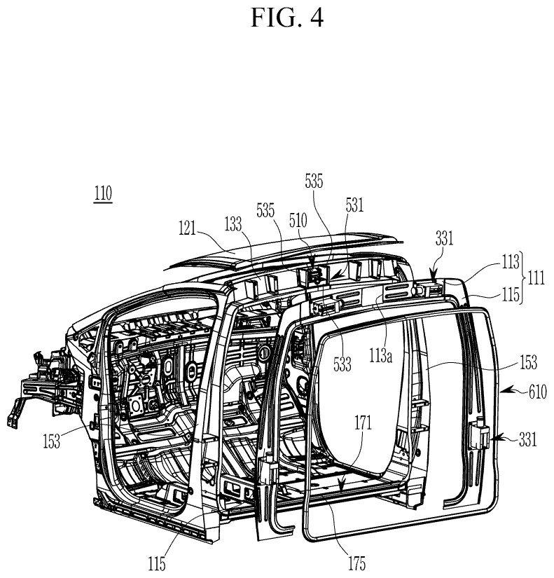

FIG. 3 is a perspective view showing the front body module applied to the joint structure of a vehicle body according to an exemplary embodiment, and FIG. 4 is an exploded perspective view showing the front body module applied to the joint structure of a vehicle body according to an exemplary embodiment.

Referring to FIG. 3 and FIG. 4, the front body module 110 according to an embodiment of the disclosure may include a fixed part cover panel 111, a fixed part roof rail assembly 131, a fixed part center pillar assembly 151, and a fixed part floor assembly 171.

The fixed part cover panel 111 is provided in the rear portion of the front body module 110. The fixed part cover panel 111 may be connected with the fixed part roof rail assembly 131 and the fixed part center pillar assembly 151, which will be explained later.

This fixed part cover panel 111 includes a fixed part roof cover 113 provided at the upper portion and a fixed part pillar cover 115 connected along the vertical direction on both sides of the fixed part roof cover 113 along the vehicle width direction.

The fixed part roof rail assembly 131 includes a fixed part roof rail 133 that is connected to the fixed part roof panel 121 disposed on the upper part of the front body module 110.

The fixed part roof rail 133 is disposed along the vehicle width direction in the rear portion of the front body module 110. In one example, the fixed part roof rail 133 may be provided in an ‘L’ cross-section shape.

Here, the fixed part roof panel 121 and the fixed part roof rail 133 are connected with the fixed part roof cover 113 of the fixed part cover panel 111 mentioned above.

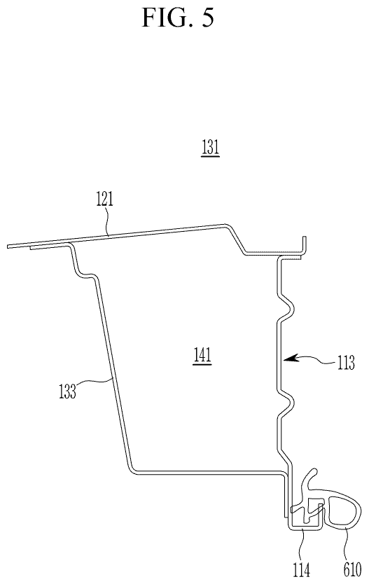

FIG. 5 is a cross-sectional view showing a roof rail assembly of a fixed part of the front body module applied to the joint structure of a vehicle body according to an exemplary embodiment.

As shown in FIG. 5, the fixed part roof cover 113, the fixed part roof panel 121, and the fixed part roof rail 133 of the fixed part roof rail assembly 131 connected with each other may form a fixed part closed cross-section 141.

The fixed part roof cover 113 includes a fixed part sealing flange 114. The fixed part sealing flange 114 is formed in a predetermined shape (e.g., bent shape) on the fixed part roof cover 113.

The fixed part center pillar assembly 151 includes fixed part center pillars 153. The fixed part center pillars 153 are disposed respectively on both sides of the rear portion of the front body module 110 in the vehicle width direction. The upper part of the fixed part center pillar 153 is connected to the fixed part roof rail 133.

The fixed part center pillar 153 is connected with the fixed part pillar cover 115 of the fixed part cover panel 111 mentioned above.

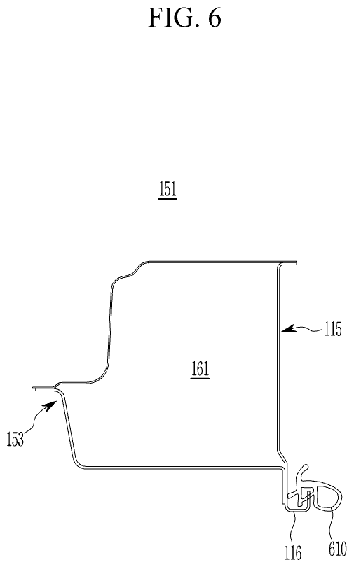

FIG. 6 is a cross-sectional view showing a fixed part center pillar assembly of the front body module applied to the joint structure of a vehicle body according to an exemplary embodiment.

As shown in FIG. 6, the fixed part pillar cover 115 and the fixed part center pillars 153 of the fixed part center pillar assembly 151 connected with each other may form a fixed part closed cross-section 161.

The fixed part pillar cover 115 includes a fixed part sealing flange 116. The fixed part sealing flange 116 is formed in a predetermined shape (e.g., bent shape) on the fixed part pillar cover 115.

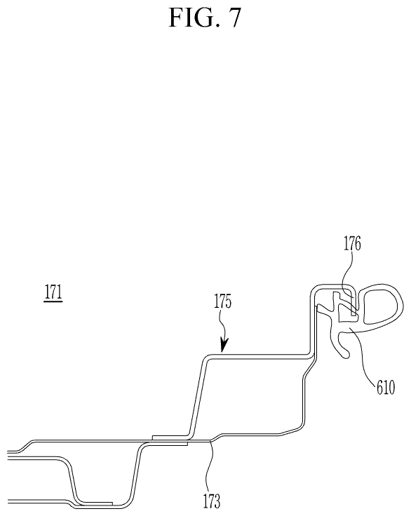

FIG. 7 is a cross-sectional view showing a fixed part floor assembly of the front body module applied to the joint structure of a vehicle body according to an exemplary embodiment.

As shown in FIG. 7, the fixed part floor assembly 171 includes a fixed part upper cross member 175 that is connected to the fixed part floor panel 173. The fixed part upper cross member 175 is connected to a lower part of the fixed part center pillar 153.

The fixed part upper cross member 175 includes a fixed part sealing flange 176. The fixed part sealing flange 176 is formed in a predetermined shape (e.g., bent shape) on the fixed part upper cross member 175.

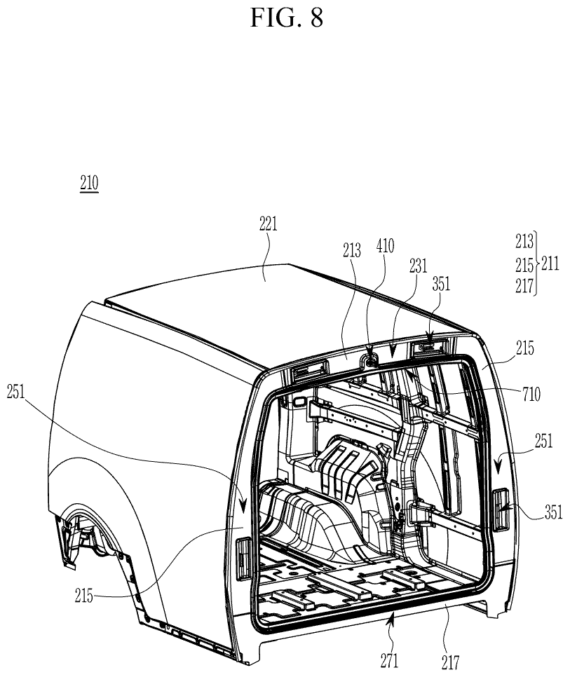

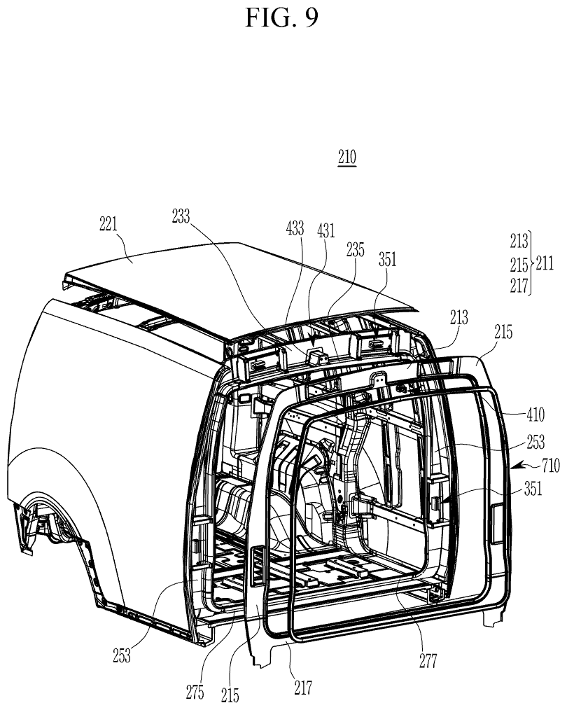

FIG. 8 is a perspective view showing the rear body module applied to the joint structure of a vehicle body according to an exemplary embodiment, and FIG. 9 is an exploded perspective view showing the rear body module applied to the joint structure of a vehicle body according to an exemplary embodiment.

Referring to FIG. 8 and FIG. 9, the rear body module 210 according to an embodiment of the disclosure may include a variable part cover panel 211, a variable part roof rail assembly 231, a variable part center pillar assembly 251, and a variable part floor assembly 271.

The variable part cover panel 211 is provided on the front portion of the rear body module 210. The variable part cover panel 211 may be connected with the variable part roof rail assembly 231, the variable part center pillar assembly 251, and the variable part floor assembly 271.

This variable part cover panel 211 may include a variable part roof cover 213, a variable part pillar cover 215, and a variable part floor cover 217.

The variable part roof cover 213 is provided as the upper part of the variable part cover panel 211. The variable part pillar cover 215 is connected to both sides of the variable part roof cover 213 in the vertical direction. The variable part floor cover 217 is connected to the lower part of the variable part pillar cover 215 along the vehicle width direction.

The variable part roof rail assembly 231 includes a variable part roof rail 233 and a variable part rail extension member 235.

The variable part roof rail 233 is disposed along the vehicle width direction on the front portion of the rear body module 210. The variable part roof rail 233 is connected with the variable part roof panel 221 disposed on the upper part of the rear body module 210. In one example, the variable part roof rail 233 may be provided in an ‘L’ cross-section shape.

The variable part rail extension member 235 is connected with the variable part roof rail 233.

The variable part roof panel 221 and the variable part rail extension member 235 are connected with the variable part roof cover 213 of the variable part cover panel 211.

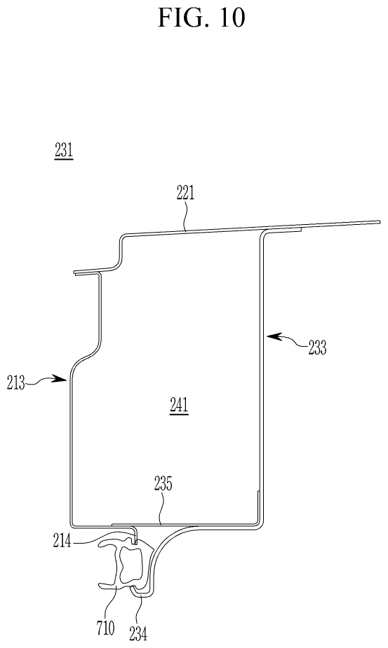

FIG. 10 is a cross-sectional view showing a roof rail assembly of a variable part of the rear body module applied to the joint structure of a vehicle body according to an exemplary embodiment.

As shown in FIG. 10, the variable part roof cover 213, the variable part roof panel 221, the variable part roof rail 233, and the variable part rail extension member 235 of the variable part roof rail assembly 231 connected with each other may form a variable part closed cross-section 241.

The variable part roof cover 213 and the variable part roof rail 233 include variable part sealing flanges 214 and 234, respectively. The variable part sealing flanges 214 and 234 are formed in a predetermined shape (e.g., bent shape) on the variable part roof cover 213 and the variable part roof rail 233.

The variable part center pillar assembly 251 includes variable part center pillars 253. The variable part center pillars 253 are disposed on both sides of the front portion of the rear body module 210, respectively. The upper part of the variable part center pillar 253 is connected to the variable part roof rail 233.

The variable part center pillar 253 is connected with the variable part pillar cover 215 of the variable part cover panel 211.

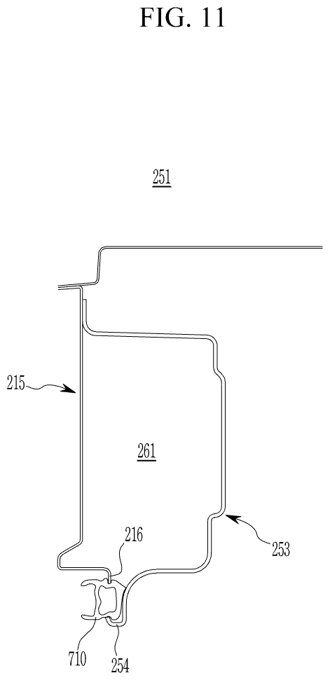

FIG. 11 is a cross-sectional view showing a variable part center pillar assembly of the rear body module applied to the joint structure of a vehicle body according to an exemplary embodiment.

As shown in FIG. 11, the variable part pillar cover 215 and the variable part center pillar 253 of the variable part center pillar assembly 251 connected with each other may form a variable part closed cross-section 261.

The variable part pillar cover 215 and the variable part center pillar 253 include variable part sealing flanges 216 and 254, respectively. The variable part sealing flanges 216 and 254 are formed in a predetermined shape (e.g., bent shape) on the variable part pillar cover 215 and the variable part center pillar 253.

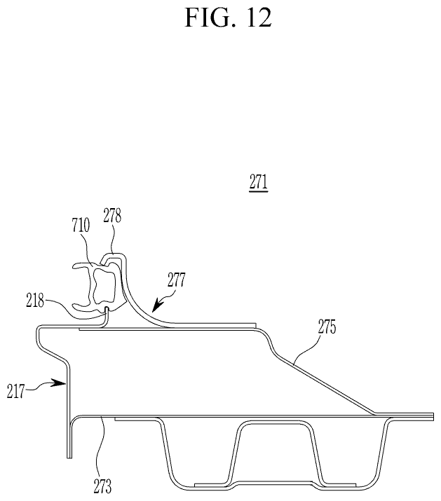

FIG. 12 is a cross-sectional view showing a variable part floor assembly of the rear body module applied to the joint structure of a vehicle body according to an exemplary embodiment.

As shown in FIG. 12, the variable part floor assembly 271 includes a variable part upper cross member 275 and a variable part floor extension member 277.

The variable part upper cross member 275 is connected to a variable part floor panel 273. The variable part floor extension member 277 is connected to the lower part of the variable part center pillar 253 and is connected to the variable part upper cross member 275.

The variable part floor panel 273 and the variable part upper cross member 275 are connected with the variable part floor cover 217 of the variable part cover panel 211.

Accordingly, the variable part floor cover 217, the variable part floor panel 273, and the variable part upper cross member 275 of the variable part floor assembly 271 connected with each other may form a closed cross-section.

The variable part floor cover 217 and the variable part floor extension member 277 include variable part sealing flanges 218 and 278, respectively. The variable part sealing flanges 218 and 278 are formed in a predetermined shape (e.g., bent shape) on the variable part floor cover 217 and the variable part floor extension member 277.

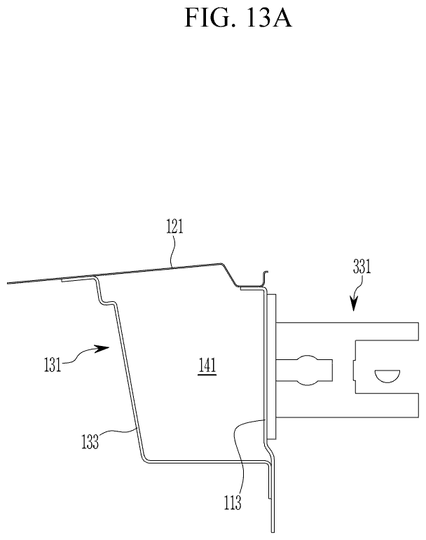

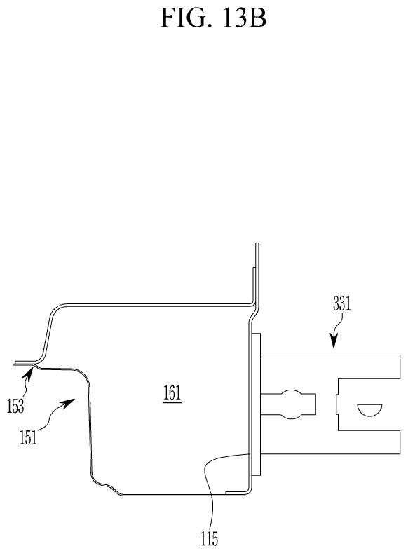

FIG. 13A and FIG. 13B are cross-sectional views showing a mounting structure of a fixed part joint of a joint unit applied to the joint structure of a vehicle body according to an exemplary embodiment.

The fixed part joints 331 of the front body module 110 are installed outside the fixed part closed cross-section 141 of the fixed part roof rail assembly 131, as shown in FIG. 13A.

The fixed part joints 331 may be connected to the fixed part roof cover 113 on the outside of the fixed part closed cross-section 141 formed by the fixed part roof cover 113, the fixed part roof panel 121, and the fixed part roof rail 133 connected with each other.

The fixed part joints 331, as shown in FIG. 13B, are installed on the outside of the fixed part closed cross-section 161 of the fixed part center pillar assembly 151.

The fixed part joints 331 may be connected to the fixed part pillar cover 115 on the outside of the fixed part closed cross-section 161 formed by the fixed part pillar cover 115 and the fixed part center pillar 153 joined together.

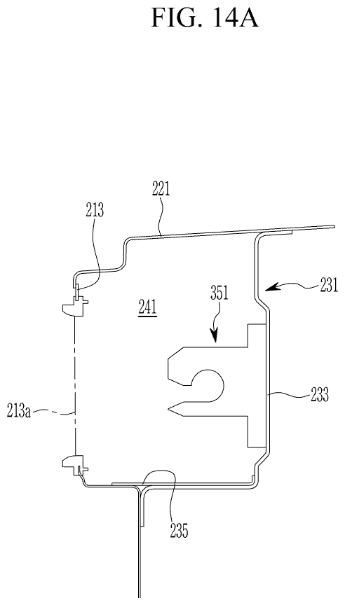

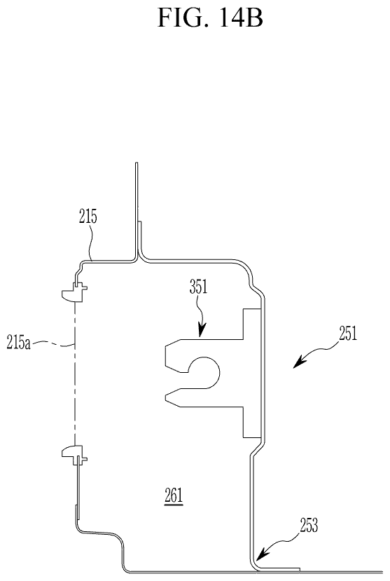

FIG. 14A and FIG. 14B are cross-sectional views showing a mounting structure of a variable part joint of the joint unit applied to the joint structure of a vehicle body according to an exemplary embodiment.

The variable part joints 351 of the rear body module 210 are connected to the inside of the variable part closed cross-section 241 of the variable part roof rail assembly 231, as shown in FIG. 14A.

The variable part joints 351 may be connected to the inner side of the variable part closed cross-section 241 formed by the variable part roof cover 213, the variable part roof panel 221, the variable part roof rail 233, and the variable part rail extension member 235 connected with each other.

As shown in FIG. 14B, the variable part joints 351 are connected to the inside of the variable part closed cross-section 261 of the variable part center pillar assembly 251.

The variable part joints 351 may be connected to the inner side of the variable part closed cross-section 261 formed by the variable part pillar cover 215 and the variable part center pillar 253 connected with each other.

The variable part roof cover 213 and the variable part pillar cover 215 include joint passing holes 213a and 215a formed at positions corresponding to each of the variable part joints 351, respectively.

In the front body module 110 configured as above, the latch assembly 510 according to an embodiment of the disclosure is installed to the fixed part roof rail assembly 131 as shown in FIG. 3 and FIG. 4.

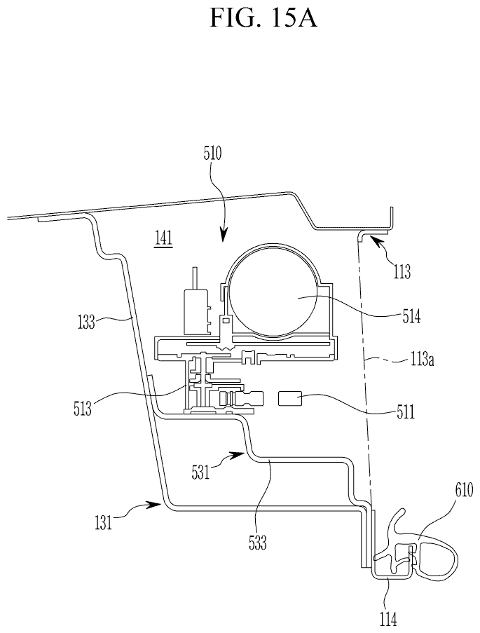

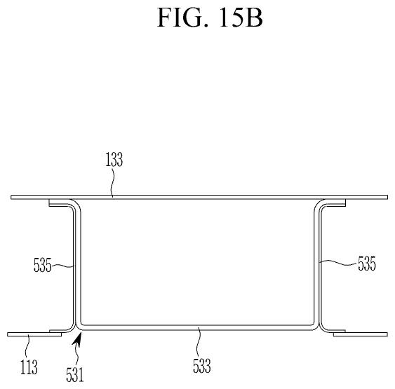

FIG. 15A and FIG. 15B are cross-sectional views showing a mounting structure of a latch assembly applied to the joint structure of a vehicle body according to an exemplary embodiment.

As shown in FIG. 15A and FIG. 15B, the latch assembly 510 is installed on the inside of the fixed part closed cross-section 141 of the fixed part roof rail assembly 131.

The latch assembly 510 is configured to selectively lock or unlock related parts (e.g., a striker). The latch assembly 510 includes a latch part 511 that connects or separates from related parts, and a latch lock part 513 that locks or unlocks the latch part 511. In the above, the latch lock part 513 can lock or unlock the latch part 511 by an actuator 514 that receives an electrical signal and operates.

Since the structure of the latch assembly 510 as described above is obvious to those skilled in the art, detailed description will be omitted.

As shown in FIG. 3, FIG. 4, FIG. 15A, and FIG. 15B, the latch assembly 510 may be installed on the inside of the fixed part closed cross-section 141 of the fixed part roof rail assembly 131 by the latch mounting unit 531.

The latch mounting unit 531 is configured to mount the latch assembly 510 on the inside of the fixed part closed cross-section 141 in the fixed part roof rail assembly 131. The latch mounting unit 531 secures the mounting strength of the latch assembly 510 and distributes the load concentrated on the latch assembly 510.

The latch mounting unit 531 is connected to the inside of the fixed part closed cross-section 141 in the fixed part roof rail assembly 131 and is connected to the latch assembly 510. The latch mounting unit 531 includes a latch mounting bulk head 533 and a pair of support bulk heads 535.

The latch mounting bulk head 533 is connected to the fixed part roof cover 113 and the fixed part roof rail 133 and is connected with the latch assembly 510.

The support bulk heads 535 are connected to both sides of the latch mounting bulk head 533 with the latch mounting bulk head 533 in between and are connected with the fixed part roof cover 113.

The fixed part roof cover 113 includes a striker passing hole 113a formed at a position corresponding to the latch assembly 510.

As shown in FIG. 8 and FIG. 9, in the rear body module 210, the striker 410 according to an embodiment of the disclosure is mounted on the variable part roof rail assembly 231.

The striker 410 shown in FIG. 3 and FIG. 4 is configured to be locked or unlocked with the latch assembly 510.

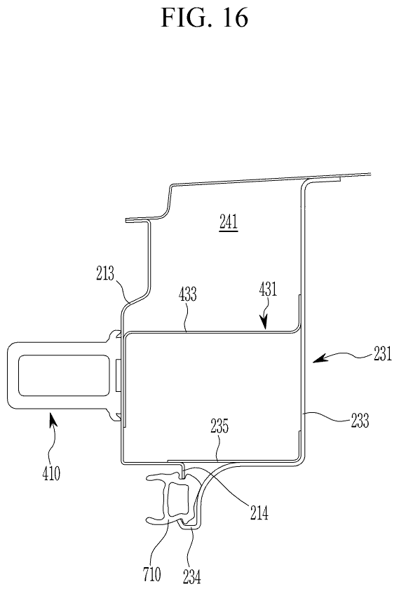

FIG. 16 is a cross-sectional view showing a mounting structure of a striker applied to the joint structure of a vehicle body according to an exemplary embodiment.

The striker 410 is mounted on the outside of the variable part closed cross-section 241 in the variable part roof rail assembly 231, as shown in FIG. 8, FIG. 9, and FIG. 16. The striker 410 is connected to the variable part roof cover 213 on the outside of the variable part closed cross-section 241.

This striker 410 may be mounted on the variable part roof cover 213 from the outside of the variable part closed cross-section 241 by the striker mounting unit 431.

The striker mounting unit 431 is configured to mount the striker 410 on the outside of the variable part closed cross-section 241 in the variable part roof rail assembly 231. The striker mounting unit 431 secures the mounting strength of the striker 410 and is configured to distribute the load concentrated on the striker 410.

The striker mounting unit 431 is connected to the inside of the variable part closed cross-section 241 in the variable part roof rail assembly 231 and is connected to the striker 410. The striker mounting unit 431 includes a striker mounting bulk head 433.

The striker mounting bulk head 433 is connected to the variable part roof cover 213, the variable part roof rail 233, and the variable part rail extension member 235 and is connected to the striker 410 with the variable part roof cover 213 in between.

On the other hand, in the front body module 110 configured as above, the fixed part inner sealing member 610 according to an embodiment of the disclosure is mounted on the fixed part roof rail assembly 131, the fixed part center pillar assembly 151, and the fixed part floor assembly 171, as shown in FIG. 3 and FIG. 4.

The fixed part inner sealing member 610 may be provided in a closed shape. The fixed part inner sealing member 610 is mounted on the fixed part sealing flange 114 of the fixed part roof cover 113 in the fixed part roof rail assembly 131 as shown in FIG. 5 and FIG. 15. The fixed part inner sealing member 610 is mounted on the fixed part sealing flange 116 of the fixed part pillar cover 115 in the fixed part center pillar assembly 151 as shown in FIG. 6. And, the fixed part inner sealing member 610 is mounted on the fixed part sealing flange 176 of the fixed part upper cross member 175 in the fixed part floor assembly 171 as shown in FIG. 7.

Additionally, in the rear body module 210 configured as above, the variable part inner sealing member 710 according to an embodiment of the disclosure is mounted on the variable part roof rail assembly 231, the variable part center pillar assembly 251, and the variable part floor assembly 271 as shown in FIG. 7 and FIG. 9.

The variable part inner sealing member 710 may be provided in a closed shape. The variable part inner sealing member 710 is mounted on the variable part sealing flanges 214 and 234 of the variable part roof cover 213 and the variable part roof rail 233 in the variable part roof rail assembly 231 as shown in FIG. 10 and FIG. 16. The variable part inner sealing member 710 is mounted on the variable part sealing flanges 216 and 254 of the variable part pillar cover 215 and the variable part center pillar 253 in the variable part center pillar assembly 251 as shown in FIG. 11. And, the variable part inner sealing member 710 is mounted on the variable part sealing flanges 218 and 278 of the variable part floor cover 217 and the variable part floor extension member 277 in variable part floor assembly 271 as shown in FIG. 12.

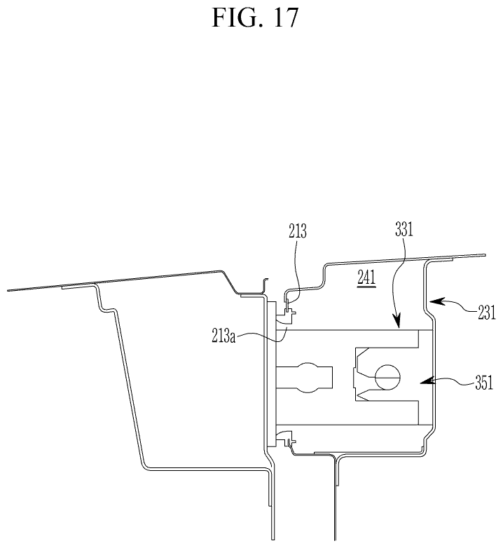

FIG. 17 to FIG. 22 are drawings to explain operations of the joint structure of a vehicle body according to an exemplary embodiment.

Hereinafter, the operation of the joint structure 100 configured as described above will be described in detail according to an exemplary embodiment referring to FIG. 1 to FIG. 22.

Referring to FIG. 1 to FIG. 16, the front body module 110 is fixed to the front part of the under body 1. The rear body module 210 is separate from the front body module 110.

In the rear portion of the front body module 110, the fixed part joints 331 of the joint unit 310 are connected on the outer side of the fixed part closed cross-section 141 of the fixed part roof rail assembly 131 and on the outer side of the fixed part closed cross-section 161 of the fixed part center pillar assembly 151.

Additionally, in the rear portion of the front body module 110, the latch assembly 510 is connected to the inside of the fixed part closed cross-section 141 of the fixed part roof rail assembly 131.

In the rear portion of the front body module 110, the fixed part inner sealing member 610 is connected to the fixed part sealing flanges 114, 116, and 176 formed in the fixed part roof rail assembly 131, the fixed part center pillar assembly 151, and the fixed part floor assembly 171, respectively.

In the front portion of the rear body module 210, the variable part joints 351 of the joint unit 310 are connected to the inside of the variable part closed cross-section 241 of the variable part roof rail assembly 231 and the inside of the variable part closed cross-section 261 of the variable part center pillar assembly 251.

In the front portion of the rear body module 210, the striker 410 is mounted on the outside of the variable part closed cross-section 241 of the variable part roof rail assembly 231.

In the front portion of the rear body module 210, the variable part inner sealing member 710 is mounted on the variable part sealing flanges 214, 216, 218, 234, 254, and 278 formed on the variable part roof rail assembly 231, the variable part center pillar assembly 251, and the variable part floor assembly 271, respectively.

In this state, the rear body module 210 moves from the rear side of the under body 1 to the lower direction and moves toward the front body module 110.

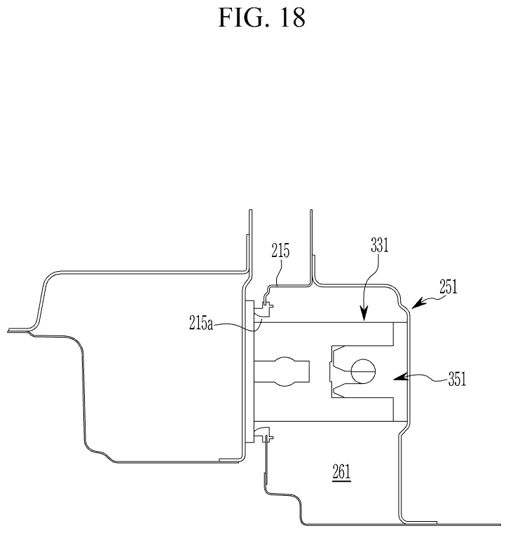

Then, as shown in FIG. 17 and FIG. 18, the fixed part joints 331 are inserted into the joint passing holes 213a and 215as of the variable part roof cover 213 and the variable part pillar cover 215.

The fixed part joints 331 are jointly coupled with variable part joints 351 on the inside of the variable part closed cross-section 241 of the variable part roof rail assembly 231 and on the inside of the variable part closed cross-section 261 of the variable part center pillar assembly 251.

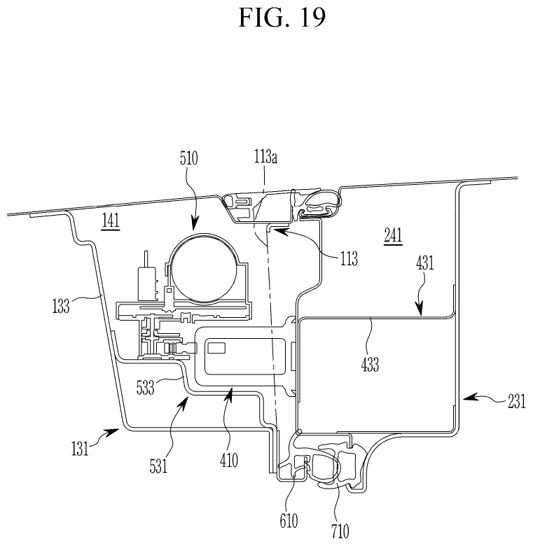

In this process, as shown in FIG. 19, the striker 410 is inserted into the striker passing hole 113a of the fixed part roof cover 113. Accordingly, the striker 410 is coupled to the latch assembly 510 on the inside of the fixed part closed cross-section 141 of the fixed part roof rail assembly 131.

The striker 410 is mounted on the outside of the variable part closed cross-section 241 through the striker mounting bulk head 433 of the striker mounting unit 431. Therefore, the striker mounting unit 431 may distribute the load concentrated on the striker 410 while securing the mounting strength of the striker 410.

And, the latch assembly 510 is mounted on the inside of the fixed part closed cross-section 141 through the latch mounting bulk head 533 and the support bulk head 535 of the latch mounting unit 531. Therefore, the latch mounting unit 531 may distribute the load concentrated on the latch assembly 510 while securing the mounting strength of the latch assembly 510.

Moisture inflowing into the inside of the fixed part closed cross-section 141 through the striker passing hole 113a may be blocked by the latch mounting unit 531. Therefore, the latch mounting unit 531 may prevent moisture from flowing into the fixed part roof rail 133 along the vehicle width direction.

In the above process, as shown in FIG. 19 to FIG. 21, the fixed part inner sealing member 610 and the variable part inner sealing member 710 are in close contact with each other and seal the inside of the front body module 110 and the rear body module 210 that are coupled to each other.

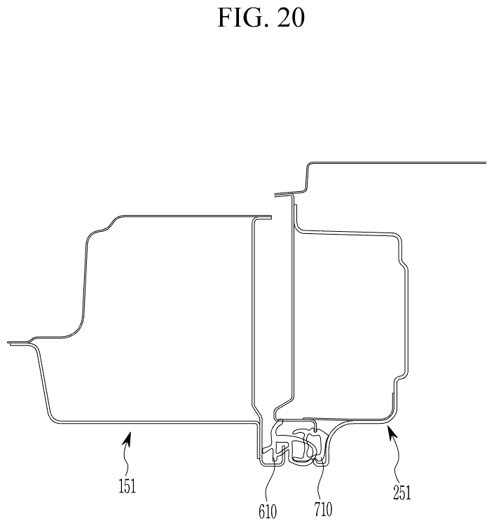

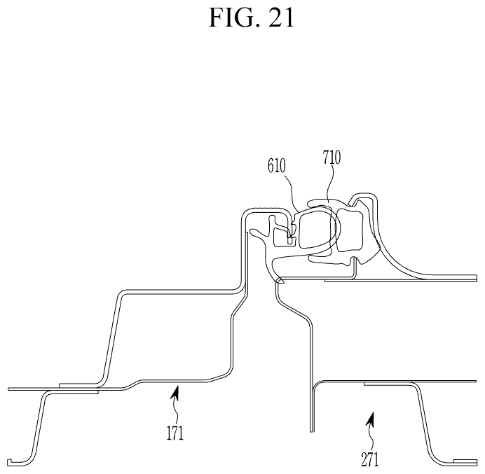

As shown in FIG. 19, the fixed part inner sealing member 610 and the variable part inner sealing member 710 can seal between the fixed part roof rail assembly 131 and the variable part roof rail assembly 231. As shown in FIG. 20, the fixed part inner sealing member 610 and the variable part inner sealing member 710 can seal between the fixed part center pillar assembly 151 and the variable part center pillar assembly 251. As shown in FIG. 21, the fixed part inner sealing member 610 and the variable part inner sealing member 710 can seal between the fixed part floor assembly 171 and the variable part floor assembly 271.

Meanwhile, as shown in FIG. 2, the outside of the front body module 110 and the rear body module 210 that are coupled to each other can be sealed through the molding member 810 and the outer sealing member 910.

The joint structure 100 according to the exemplary embodiments described above may combine the front body module 110 and the rear body module 210 through the fixed part joints 331 and the variable part joints 351 of the joint unit 310.

In addition, the joint structure 100 according to an exemplary embodiment can combine the front body module 110 and the rear body module 210 through the striker 410 and the latch assembly 510.

Therefore, even if the connection force between the fixed part joints 331 and the variable part joints 351 is insufficient or lost, the striker 410 and the latch assembly 510 can prevent separation of the front body module 110 and the rear body module 210.

And, according to an exemplary embodiment, the joint structure 100 can seal the inside and outside of the front body module 110 and the rear body module 210 coupled to each other through the fixed part inner sealing member 610, the variable part inner sealing member 710, the molding member 810, and the outer sealing member 910.

As a result, the joint structure 100 according to an exemplary embodiment can secure the sealing performance and watertight performance of the front body module 110 and the rear body module 210 that are coupled to each other.

Meanwhile, the fixed part sealing flanges 114, 116, and 176 of the front body module 110 and the variable part sealing flanges 214, 216, 218, 234, 254, and 278 of the rear body module 210 can prevent rotation of the rear body module 210 even if the coupling force between the front body module 110 and the rear body module 210 is insufficient or lost.

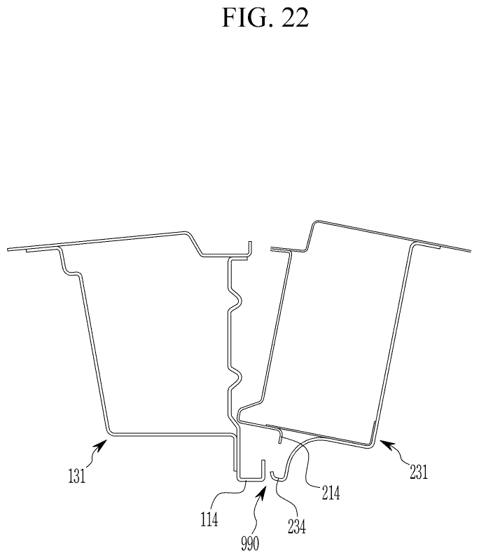

For example, as shown in FIG. 22, the fixed part sealing flange 114 of the fixed part roof rail assembly 131 and the variable part sealing flanges 214 and 234 of the variable part roof rail assembly 231 may be provided as a stopper 990 to prevent rotation of the rear body module 210 with respect to the front body module 110 (see FIG. 1).

According to the joint structure 100 according to an exemplary embodiment, the front body module 110 as the fixed part 110a coupled to the front part of the under body 1 is left as is, and the rear body module 210 as the variable part 210a may be coupled to the upper part of the under body 1 and the rear part of the front body module 110.

Therefore, according to an exemplary embodiment, the joint structure 100 replaces the rear body module 210 of a predetermined shape, depending on the type of customized service (e.g., use case) of the PBV, and the PBV may be of a hailing type or a delivery type vehicle.

As a result, the joint structure 100 according to an exemplary embodiment can reduce the cost of configuring the vehicle body to suit the various customized services of the PBV.

Furthermore, the joint structure 100 according to an exemplary embodiment can smoothly distribute the load input to the front body module 110 and the rear body module 210 that are coupled to each other, thereby improving the collision performance and torsional strength of the vehicle body, etc.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A joint structure of a vehicle body, the vehicle body comprising a front body module fixed to an under body and a rear body module that is detachably coupled to the front body module along a front to rear direction of the vehicle body, the joint structure comprising:
a joint unit disposed in a rear portion of the front body module and a front portion of the rear body module, respectively;
a striker mounted on an outside of a first closed cross-section defined in either the rear portion of the front body module or the front portion of the rear body module; and
a latch assembly disposed on an inside of a second closed cross-section defined in the other of the rear portion of the front body module and the front portion of the rear body module.

2. The joint structure of claim 1, wherein:
the front body module comprises a fixed part roof rail assembly with a fixed part closed cross-section connected with a fixed part roof panel; and
the rear body module comprises a variable part roof rail assembly with a variable part closed cross-section connected with a variable part roof panel.

3. The joint structure of claim 2, wherein:
the striker is mounted on an outside of the variable part closed cross-section; and
the latch assembly is installed on an inside of the fixed part closed cross-section.

4. The joint structure of claim 3, wherein the striker is locked and unlocked with the latch assembly through a striker passing hole disposed in the fixed part roof rail assembly.

5. The joint structure of claim 2, wherein:
the front body module comprises a latch mounting unit connected to an inside of the fixed part closed cross-section and connected to the latch assembly; and
the rear body module comprises a striker mounting unit connected to an inside of the variable part closed cross-section and connected to the striker.

6. The joint structure of claim 5, wherein the fixed part roof rail assembly comprises:
a fixed part roof rail connected with the fixed part roof panel; and
a fixed part roof cover connected with the fixed part roof panel and the fixed part roof rail.

7. The joint structure of claim 6, wherein the latch mounting unit comprises:
a latch mounting bulk head connected with the fixed part roof rail and the fixed part roof cover and connected with the latch assembly; and
a pair of support bulk heads each connected to both sides of the latch mounting bulk head with the latch mounting bulk head in between and connected with the fixed part roof cover.

8. The joint structure of claim 5, wherein the variable part roof rail assembly comprises:
a variable part roof rail connected with the variable part roof panel;
a variable part rail extension member connected with the variable part roof rail; and
a variable part roof cover combined with the variable part roof panel and the variable part rail extension member.

9. The joint structure of claim 8, wherein the striker mounting unit comprises a striker mounting bulk head that is connected with the variable part roof rail, the variable part rail extension member, and the variable part roof cover and is connected with the striker with the variable part roof cover in between.

10. A joint structure of a vehicle body, the vehicle body comprising a front body module fixed to an under body and a rear body module that is detachably coupled to the front body module along a front to rear direction of the vehicle body, the joint structure comprising:
a joint unit disposed in a rear portion of the front body module and a front portion of the rear body module, respectively;
a fixed part sealing flange disposed on a fixed part roof rail assembly, a fixed part center pillar assembly, and a fixed part floor assembly respectively connected to the rear portion of the front body module to mount a fixed part inner sealing member; and
a variable part sealing flange disposed on a variable part roof rail assembly, a variable part center pillar assembly, and a variable part floor assembly respectively connected to the front portion of the rear body module to mount a variable part inner sealing member.

11. The joint structure of claim 10, wherein:
the fixed part roof rail assembly comprises a fixed part roof rail connected to a fixed part roof panel and a fixed part roof cover connected to the fixed part roof panel and the fixed part roof rail; and
the variable part roof rail assembly comprises a variable part roof rail connected with a variable part roof panel, a variable part rail extension member connected with the variable part roof rail, and a variable part roof cover connected with the variable part roof panel and the variable part rail extension member.

12. The joint structure of claim 11, wherein:
the fixed part sealing flange is disposed on the fixed part roof cover; and
the variable part sealing flange is disposed on the variable part roof rail and the variable part roof cover.

13. The joint structure of claim 10, wherein:
the fixed part center pillar assembly comprises a fixed part center pillar and a fixed part pillar cover connected to the fixed part center pillar; and
the variable part center pillar assembly comprises a variable part center pillar and a variable part pillar cover connected to the variable part center pillar.

14. The joint structure of claim 13, wherein:
the fixed part sealing flange is disposed on the fixed part pillar cover; and
the variable part sealing flange is disposed on the variable part center pillar and the variable part pillar cover.

15. The joint structure of claim 10, wherein:
the fixed part floor assembly comprises a fixed part upper cross member connected to a fixed part floor panel; and
the variable part floor assembly comprises a variable part upper cross member connected to a variable part floor panel, a variable part floor extension member connected to the variable part upper cross member, and a variable part floor cover connected to the variable part floor panel and the variable part upper cross member.

16. The joint structure of claim 15, wherein:
the fixed part sealing flange is disposed on the fixed part upper cross member; and
the variable part sealing flange is disposed on the variable part floor extension member and the variable part floor cover.

17. The joint structure of claim 10, wherein the fixed part sealing flange and the variable part sealing flange are configured to act as stoppers to prevent rotation of the rear body module.

18. A vehicle body comprising:
an under body;
a front body module coupled to the under body, the front body module comprising a fixed part roof rail assembly with a fixed part closed cross-section connected with a fixed part roof panel;
a rear body module detachably coupled to the front body module along a front to rear direction of the vehicle body, the rear body module comprising a variable part roof rail assembly with a variable part closed cross-section connected with a variable part roof panel;
a joint unit disposed in a rear portion of the front body module and a front portion of the rear body module, respectively;
a striker mounted on an outside of a first closed cross-section defined in either the rear portion of the front body module or the front portion of the rear body module;
a latch assembly disposed on an inside of a second closed cross-section defined in the other of the rear portion of the front body module and the front portion of the rear body module;
a fixed part sealing flange disposed on the fixed part roof rail assembly, a fixed part center pillar assembly, and a fixed part floor assembly respectively connected to the rear portion of the front body module to mount a fixed part inner sealing member; and
a variable part sealing flange disposed on the variable part roof rail assembly, a variable part center pillar assembly, and a variable part floor assembly respectively connected to the front portion of the rear body module to mount a variable part inner sealing member.

19. The vehicle body of claim 18, wherein:
the striker is mounted on an outside of the variable part closed cross-section;
the latch assembly is installed on an inside of the fixed part closed cross-section;
the fixed part roof rail assembly comprises a fixed part roof rail connected to the fixed part roof panel and a fixed part roof cover connected to the fixed part roof panel and the fixed part roof rail; and
the variable part roof rail assembly comprises a variable part roof rail connected with the variable part roof panel, a variable part rail extension member connected with the variable part roof rail, and a variable part roof cover connected with the variable part roof panel and the variable part rail extension member;
the fixed part sealing flange is disposed on the fixed part roof cover; and
the variable part sealing flange is disposed on the variable part roof rail and the variable part roof cover.

20. The vehicle body of claim 18, wherein:
the front body module comprises a latch mounting unit connected to an inside of the fixed part closed cross-section and connected to the latch assembly;
the rear body module comprises a striker mounting unit connected to an inside of the variable part closed cross-section and connected to the striker;
the fixed part center pillar assembly comprises a fixed part center pillar and a fixed part pillar cover connected to the fixed part center pillar;
the variable part center pillar assembly comprises a variable part center pillar and a variable part pillar cover connected to the variable part center pillar;
the fixed part sealing flange is disposed on the fixed part pillar cover; and
the variable part sealing flange is disposed on the variable part center pillar and the variable part pillar cover.
